(19) United States
(12) Patent Application Publication
(10) Pub. No.: US 2015/0242853 A1
(43) Pub. Date: Aug. 27, 2015

(54) PAYMENT ACCOUNT TOKENIZATION METHOD

(71) Applicant: MasterCard International Incorporated, Purchase, NY (US)

(72) Inventor: Jonathan R. Powell, Rye Brook, NY (US)

(21) Appl. No.: 14/538,548

(22) Filed: Nov. 11, 2014

Related U.S. Application Data
(60) Provisional application No. 61/944,664, filed on Feb. 26, 2014.

(51) Int. Cl. G06Q 20/40; G06Q 20/38

(52) U.S. Cl. CPC G06Q 20/40; G06Q 20/382

(57) ABSTRACT

A method includes receiving a bank identification number (BIN) that defines a range of indicator numbers, and generating a plurality of primary account numbers (PANs) that start with that BIN. The method further includes generating a plurality of tokens that start with the same BIN. The PANs may have a prescribed length in digits that differs from the prescribed length in digits for the tokens. Thus tokens can be distinguished from PANs based on length in digits, even though the PANs and tokens may be formed with the same BIN.

### CROSS REFERENCE TO RELATED APPLICATION

This application claims the benefit of U.S. Provisional Patent Application No. 61/944,664 filed on Feb. 26, 2014, the contents of which are hereby incorporated by reference for all purposes.

### BACKGROUND

In November 2013, MasterCard International Incorporated (the assignee hereof), Visa and American Express jointly published guidelines entitled “Payment Token Interoperability Standard” (hereinafter referred to as the “Tokenization Standard”). The Tokenization Standard referred to a known concept called “tokenization,” in which surrogate values (“tokens”) replace primary account numbers (PANs) during part of the operation of payment systems. One reason for using tokens in place of PANs is to combat potentially fraudulent activities.

The first four to six digits of a PAN (often six digits) typically identify the issuing financial institution for the PAN or otherwise are key for routing transactions in a payment system. This portion of the PAN is known as the BIN (Bank Identification Number) or IIN (Issuer Identification Number). If tokens are to be used for routing of transactions, as proposed in the Tokenization Standard, the leading digits of the tokens must also be constituted by a BIN. According to a proposal in the Tokenization Standard, tokens are not to have the same BINs as PANs. In other words, the Tokenization Standard proposes that certain BIN ranges be assigned exclusively for generating tokens, with such token-dedicated BINs not to be shared with PANs.

The present inventor has recognized that there are a finite number of BINs that are available, that it may be desirable to have BIN tables that are not excessively large, that some routing and processing logic may based on an extended range beyond the leading 6 digits of the PAN, and that it may be desirable for at least some BIN ranges to be shared by tokens and PANs. The present disclosure proposes an alternative manner for distinguishing between PANs and tokens apart from having dedicated BINs reserved for tokens.

### BRIEF DESCRIPTION OF THE DRAWINGS

Features and advantages of some embodiments of the present disclosure, and the manner in which the same are accomplished, will become more readily apparent upon consideration of the following detailed description of the disclosure taken in conjunction with the accompanying drawings, which illustrate preferred and exemplary embodiments and which are not necessarily drawn to scale, wherein:

FIG. 1 is a block diagram that illustrates a system in which the present disclosure may be applied.

FIG. 1A is a block diagram that illustrates a conventional payment system, in which tokenization need not necessarily be employed.

FIG. 2 is a block diagram representation of a computer system that may perform at least some functions in accordance with aspects of the present disclosure.

FIG. 3 is a flow chart that illustrates a process that may be performed in accordance with aspects of the present disclosure.

FIG. 3A pictorially illustrates a mapping of tokens to PANs that may occur in the computer system of FIG. 2 and the process of FIG. 3.

FIG. 4 is a flow chart that illustrates details of the process of FIG. 3.

FIG. 5 is a flow chart that illustrates another process that may be performed in accordance with aspects of the present disclosure.

### DETAILED DESCRIPTION

In general, and for the purpose of introducing concepts of the present disclosure, PANs and tokens used in a payment system may both start with the same BIN, but may be distinguished from each other by prescribing different standard lengths (in terms of the number of digits) for PANs versus tokens. For example, in some embodiments, PANs may all be of the commonly used standard length of 16 digits, while all tokens sharing the same BIN(s) with the PANs may have a standard length of 19 digits (which is the length of the account number field in the applicable ISO (International Standards Organization) specifications).

With such an arrangement, the routing process for authorization requests may include a stage of detecting the length of the “account number” included in the request to detect whether it is a PAN or a token. The process may then branch accordingly, with a token being translated to its corresponding PAN if the authorization request includes a token rather than a PAN.

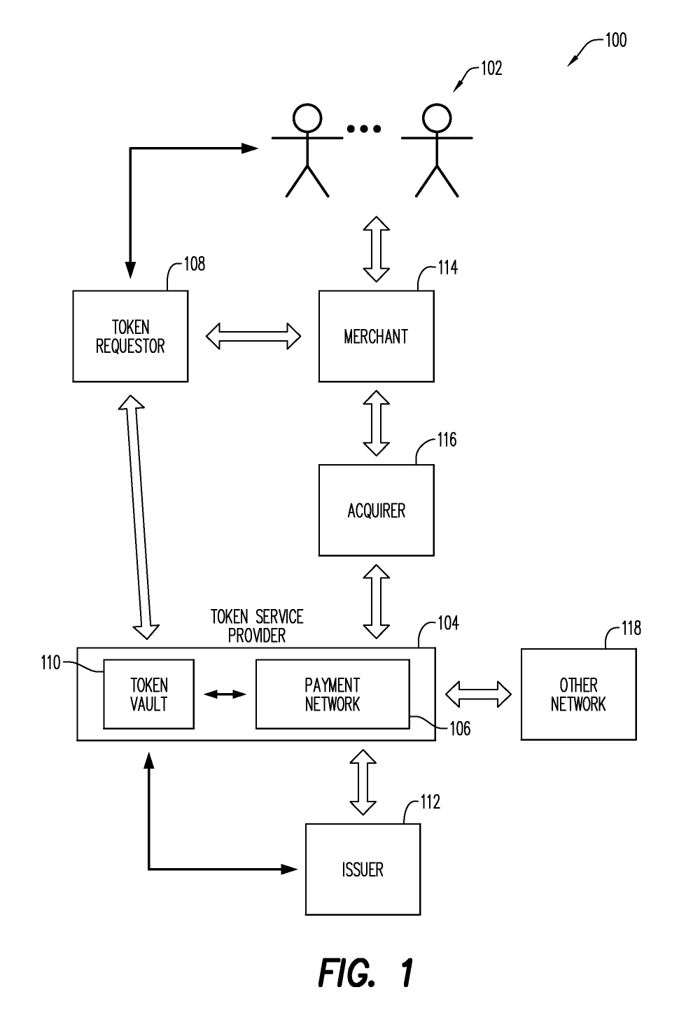

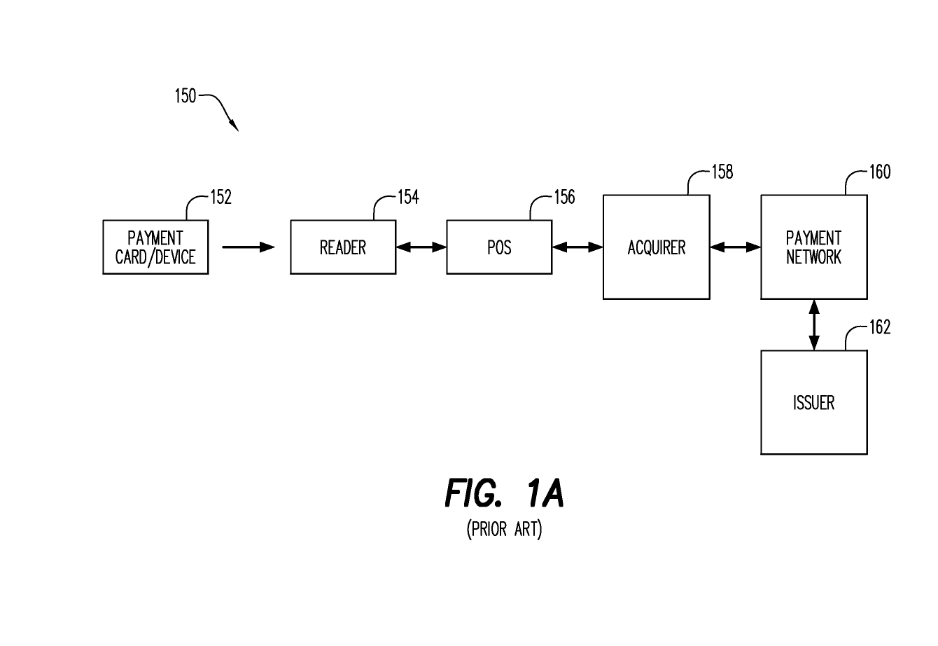

By way of background, a conventional payment system will first be briefly described. FIG. 1A is a block diagram that illustrates a conventional payment system 150. Tokenization is not necessarily employed in the payment system 150.

The system 150 includes a conventional payment card/device 152. As is familiar to those who are skilled in the art, the payment card/device 152 may be a magnetic stripe card, an IC (integrated circuit) card, a fob, a payment-enabled smartphone, etc.

The system 150 further includes a reader component 154 associated with a POS terminal 156. In some known manner (depending on the type of the payment card/device 152) the reader component 154 is capable of reading the payment card account number and other information from the payment card/device 152.

The reader component 154 and the POS terminal 156 may be located at the premises of a retail store and operated by a sales associate of the retailer for the purpose of processing retail transactions. The payment card/device 152 is shown in FIG. 1A to be interacting with the reader component 154 and the POS terminal 156 for the purpose of executing such a transaction.

A computer 158 operated by an acquirer (acquiring financial institution) is also shown as part of the system 150 in FIG. 1A. The acquirer computer 158 may operate in a conventional manner to receive an authorization request for the transaction from the POS terminal 156. The acquirer computer 158 may route the authorization request via a payment network 160 to the server computer 162 operated by the issuer of a payment card account that is associated with the payment card/device 152. As is also well known, the authorization response generated by the payment card issuer server computer 162 may be routed back to the POS terminal 156 via the payment network 160 and the acquirer computer 158.

One well known example of a payment network is referred to as the “Banknet” system, and is operated by MasterCard International Incorporated, which is the assignee hereof.

The payment card issuer server computer 162 may be operated by or on behalf of a financial institution (“FI”) that issues payment card accounts to individual users. For example, the payment card issuer server computer 162 may perform such functions as (a) receiving and responding to requests for authorization of payment card account transactions to be charged to payment card accounts issued by the FI; and (b) tracking and storing transactions and maintaining account records.

The components of the system 150 as depicted in FIG. 1A are only those that are needed for processing a single transaction. A typical payment system may process many purchase transactions (including simultaneous transactions) and may include a considerable number of payment card issuers and their computers, a considerable number of acquirers and their computers, and numerous merchants and their POS terminals and associated proximity reader components. The system may also include a very large number of payment card account holders, who carry payment cards or other devices for initiating payment transactions by presenting an associated payment card account number to the reader component of a POS terminal.

As will be evident to those who are skilled in the art, the above description of conventional payment system practices is oriented toward transactions that occur in-store, i.e., in person. It is also well known that many payment card transactions in conventional payment systems are performed in e-commerce environments. That is, holders of payment account cards frequently use them for online shopping. In doing so, they access a retailer's e-commerce website (often called an “online store”), select one or more items for purchase, opt for a “check out” phase of the process, and (in some cases) enter their payment card account number and other information to permit the retailer's e-commerce host computer to generate a payment system authorization request. The payment system authorization request generated by the e-commerce host computer may be similar to the authorization request referred to above in connection with the POS terminal 156 of FIG. 1A. As is well known, in the online shopping environment, the retailer's e-commerce host may transmit the authorization request to an acquirer computer 158 in a similar fashion as if the e-commerce host were a POS terminal located in a brick-and-mortar store.

The discussion will now turn to tokenization and to a description of how teachings of the present disclosure may be applied in connection with a payment system in which tokenization is employed.

FIG. 1 is a block diagram that illustrates a payment system 100 in which teachings of the present disclosure may be applied. (FIG. 1 is adapted from the “FIG. 1” presented on page 10 of the Tokenization Standard.)

Individual users/cardholders are indicated by reference numeral 102 in FIG. 1.

FIG. 1 also includes a block 104 that represents a token service provider. The token service provider 104 may in some embodiments also be the operator of a payment network (block 106), such as that operated by MasterCard International Incorporated, the assignee hereof. The token service provider 104 may be authorized in the payment system 100 to issue tokens to token requestors (one such token requestor represented by block 108 in FIG. 1). In issuing tokens, the token service provider 104 may perform such functions as operating and maintaining a token vault 110, generating and issuing tokens (in accordance, e.g., with aspects of the present disclosure), assuring security and proper controls, token provisioning (e.g., personalizing payment cards, etc. with token values), and registering token requestors.

In addition to representing the token service provider, block 104 should also be understood to represent one or more computer systems operated by the token service provider.

Block 112 in FIG. 1 represents an issuer of payment card accounts held by the cardholders 102. In some embodiments, some or all of the functions of the token service provider 104 may be taken on by the issuer 112.

Block 114 in FIG. 1 represents a merchant to which the cardholders may present payment devices (payment cards and/or payment-enabled smartphones, etc., none of which are shown in the drawing) to consummate a purchase transaction. In some cases the merchant 114 may also be a token requestor 108 (e.g., for implementing a tokenized card-on-file arrangement for e-commerce transactions with a cardholder 102). As is conventional, the merchant may receive a token value from a cardholder's payment device and issue an authorization request to initiate processing of a payment transaction in the payment system 100.

Block 116 in FIG. 1 represents an acquirer. As is well known, the acquirer may be a financial institution that provides banking services to the merchant 114, and that receives and routes authorization requests originated from the merchant 114.

Referring again to block 108 (token requestor), this role may be taken on by entities such as card-on-file merchants (as noted above); acquirers, acquirer processors, and payment gateways (acting for merchants); payment enablers such as OEMs (original equipment manufacturers); digital wallet service providers or issuers 112. Token requestors may be required to register with the token service provider 104.

Also shown in FIG. 1 is a block 118, representing another payment network with which the token service provider 104 may interact.

It will be readily appreciated that a practical embodiment of the payment system 100 may include numerous merchants, token requestors, acquirers and issuers, rather than one of each as depicted in FIG. 1.

At this point the term “indicator number” will be introduced. This term should be understood to include both PANs and tokens.

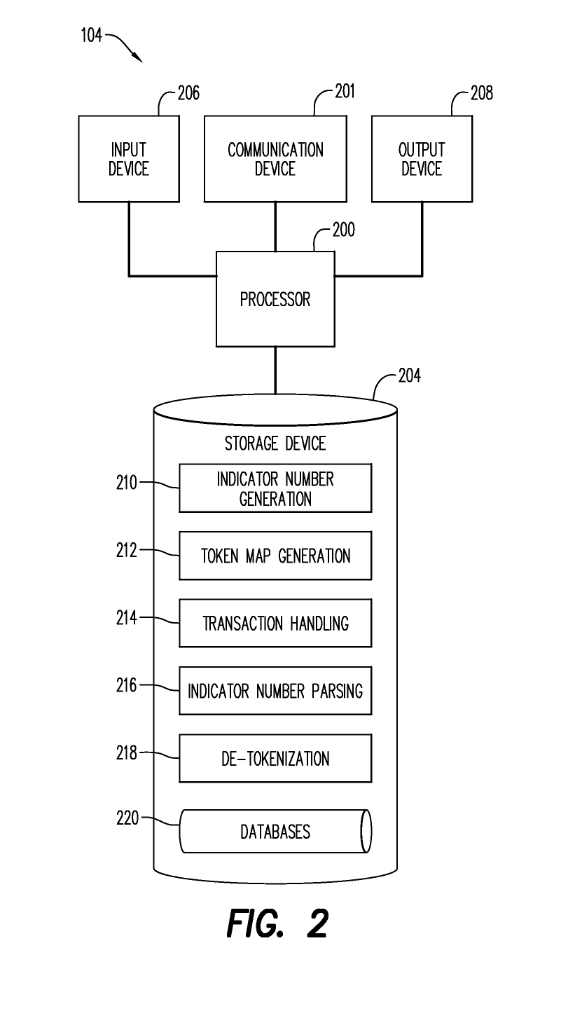

FIG. 2 is a block diagram representation of a computer system that may be operated by the token service provider in accordance with aspects of the present disclosure. This computer system, indicated by reference numeral 104, may be referred to as the “token service provider computer 104” and may perform at least some functions in accordance with aspects of the present disclosure.

The token service provider computer 104 may be conventional in its hardware aspects but may be controlled by software to cause it to function as described herein. For example, the token service provider computer 104 may be constituted by conventional server computer hardware. In some embodiments, functionality disclosed herein may be distributed among two or more computers having hardware architecture similar to that described below.

The token service provider computer 104 may include a computer processor 200 operatively coupled to a communication device 201, a storage device 204, an input device 206 and an output device 208.

The computer processor 200 may be constituted by one or more conventional processors. Processor 200 operates to execute processor-executable steps, contained in program instructions described below, so as to control the token service provider computer 104 to provide desired functionality.

Communication device 201 may be used to facilitate communication with, for example, other devices (such as other components of the payment system 100 shown in FIG. 1). For example (and continuing to refer to FIG. 2), communication device 201 may comprise numerous communication ports (not separately shown), to allow the token service provider computer 104 to communicate simultaneously with a number of other computers and other devices.

Input device 206 may comprise one or more of any type of peripheral device typically used to input data into a computer. For example, the input device 206 may include a keyboard and a mouse. Output device 208 may comprise, for example, a display and/or a printer.

Storage device 204 may comprise any appropriate information storage device, including combinations of magnetic storage devices (e.g., magnetic tape and hard disk drives), optical storage devices such as CDs and/or DVDs, and/or semiconductor memory devices such as Random Access Memory (RAM) devices and Read Only Memory (ROM) devices, as well as so-called flash memory. Any one or more of such information storage devices may be considered to be a computer-readable storage medium or a computer usable medium or a memory.

Storage device 204 stores one or more programs for controlling processor 200. The programs comprise program instructions (which may be referred to as computer readable program code means) that contain processor-executable process steps of the token service provider computer 104, executed by the processor 200 to cause the token service provider computer 104 to function as described herein.

The programs may include one or more conventional operating systems (not shown) that control the processor 200 so as to manage and coordinate activities and sharing of resources in the token service provider computer 104, and to serve as a host for application programs (described below) that run on the token service provider computer 104.

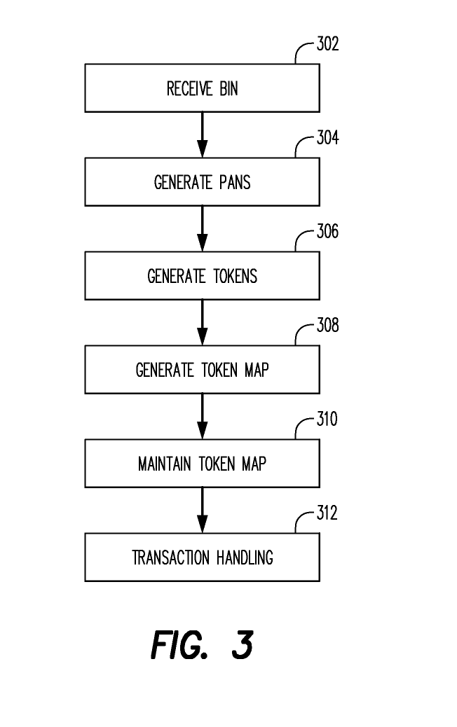

The programs stored in the storage device 204 may also include an indicator number generation program 210 that controls the processor 200 to enable the token service provider computer 104 to generate either or both of tokens and PANs. Details of the functionality provided by the indicator number generation program 210 will be discussed below in conjunction with FIG. 3.

Another program that may be stored in the storage device 204 is an application program or program module 212 that controls the processor 200 to enable the token service provider computer 104 to generate a mapping of tokens relative to the PANs that they represent. This program 212 will hereafter be referred to as the token map generation application program; functionality thereof will be described below in conjunction with FIG. 3.

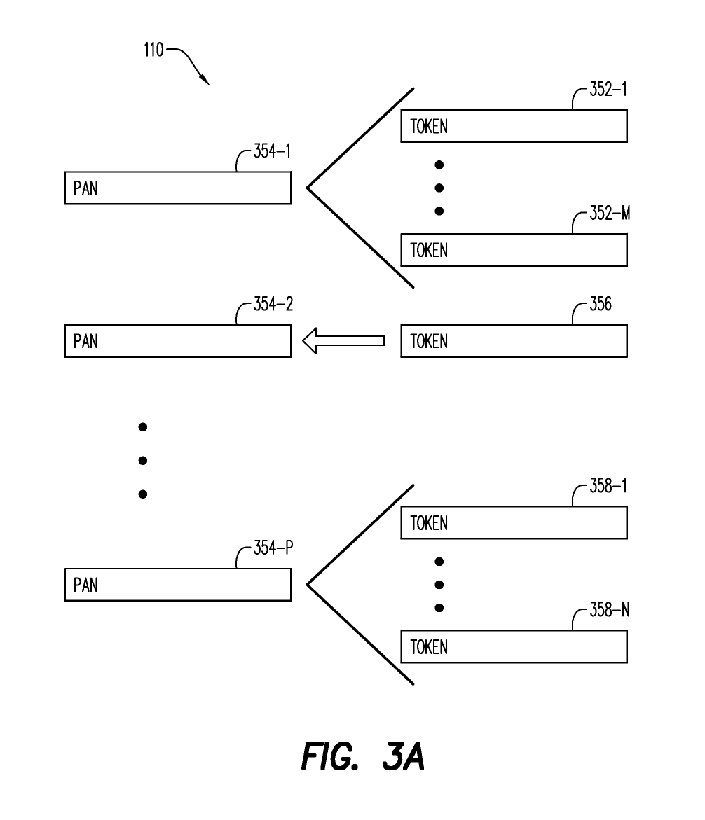

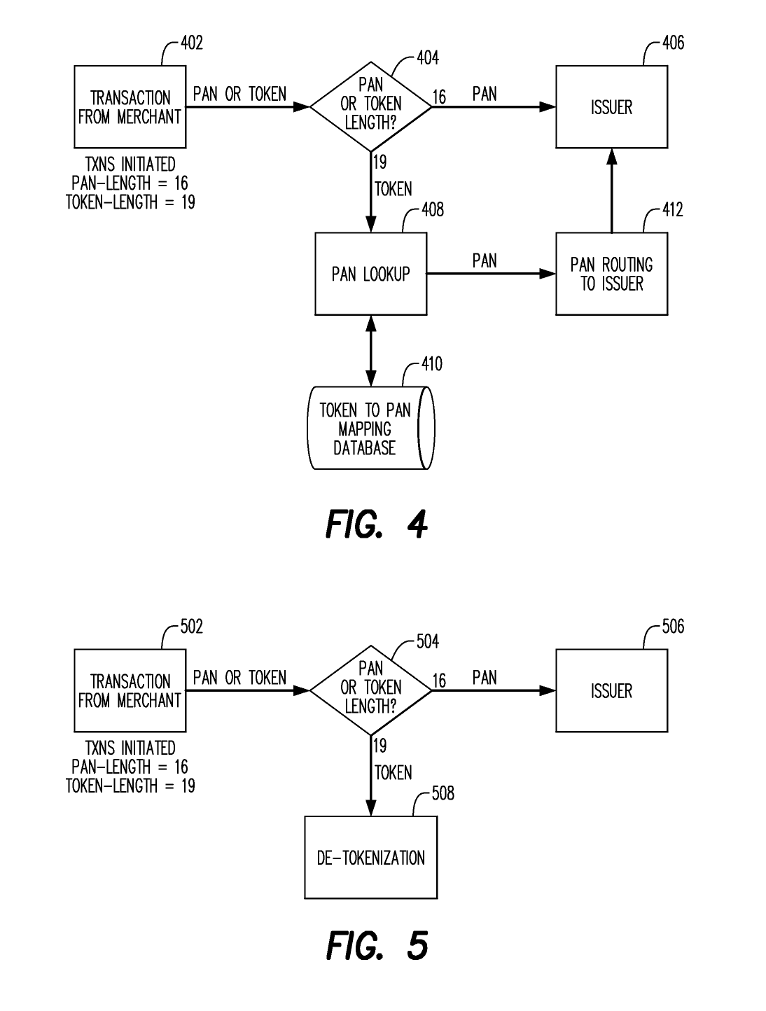

Still further, the storage device 204 may also store an application program 214 that controls the processor 200 to enable the token service provider computer 104 to handle requests that it receives (e.g., from acquirers) in connection with current payment card account transactions. In addition, the storage device 204 may store a program or program module 216, which, as described below, controls the processor 200 to enable the token service provider computer 104 to examine indicator numbers received in authorization requests to determine whether the indicator numbers are PANs or tokens. Details of the functionality provided by program/program module 216 are described below in connection with FIG. 4.

Moreover, the storage device 204 may further store a program/program module 218 that enables the token service provider computer 104 to perform de-tokenization with respect to tokens that it receives for that purpose. The de-tokenization enabled by program/program module 218 may in general be consistent with the proposals contained in the above-referenced Tokenization Standard (noting however that the token format proposed in this disclosure is different from that proposed in the Tokenization standard). As is known to those who are skilled in the art, “de-tokenization” refers to substituting a PAN for a token that represented the PAN.

The storage device 204 may also store, and the token service provider computer 104 may also execute, other programs, which are not shown. For example, such programs may include a reporting application, which may respond to requests from system administrators for reports on the activities performed by the token service provider computer 104. The other programs may also include, e.g., communication software, database management software, device drivers, etc.

The storage device 204 may also store one or more databases 220 required for operation of the token service provider computer 104. Those databases 220 may, for example, include the token vault 110 shown in FIG. 1.

In some embodiments, at least some of the functionality ascribed below to the token service provider computer 104 may alternatively be performed by another computer or computers in the payment system 100 of FIG. 1 (e.g., by a computer or computers operated by the issuer 112 or by the acquirer 116). Such computer or computers may have essentially the same hardware architecture as the token service provider computer 104, and like the token service provider computer 104, may be programmed by suitable software program instructions to provide functionality as described herein.

FIG. 3 is a flow chart that illustrates a process that may be performed in accordance with aspects of the present disclosure. The process steps illustrated in FIG. 3 may be performed by the token service provider computer 104 and/or by a computer or computers operated by the issuer 112 (FIG. 1).

Continuing to refer to FIG. 3, at block 302 the token service provider computer 104 (and/or another computer) receives one or more BINs that have been assigned for use both for generating PANs and for generating tokens in accordance with aspects of this disclosure. That is, for a given BIN, both PANs and tokens are to be generated using the BIN in question. For example, a given one of the BINs (or more than one) may have been assigned by the operator of the payment network 106 for use by the issuer 112 in generating PANs for payment card accounts issued by the issuer 112. Typically, in accordance with conventional practices, the BIN(s) may be constituted with six digits, and are uniquely assigned to the issuer in question.

At block 304, PANs are generated using a BIN received at 302. In some embodiments, the token service provider computer 104 may generate the PANs on behalf of the issuer 112 and at the issuer's request. In other embodiments, the issuer 112 itself may issue the PANs. In any case, each of the PANs generated at 304 is required to consist of a standard number of digits, say 16 digits in accordance with widespread practices. Thus, in such a case, each PAN is formed from the six-digit BIN in question plus ten more digits. The PANs in question may be generated in accordance with conventional practices. As is customary, for example, one digit, such as the last (sixteenth) digit, may be a check digit.

At block 306, tokens are generated using the same BIN that was used at 304 to generate PANs. In accordance with aspects of the present disclosure, the tokens generated at 306 are required to consist of a standard number of digits that is different from the number of digits prescribed for the PANs. In some embodiments, for example, each token generated at 306 is required to contain exactly 19 digits. Thus, in some embodiments, each token may be formed of a six-digit BIN plus 13 more digits. Such a length in digits is accommodated by the relevant ISO standard, in which the relevant data field will accommodate up to 19 digits.

The tokens may be formed in accordance with any process that is convenient. For example, sequential numbers may be used. In some embodiments, random number generation may be employed. In still other embodiments, an encryption process may be employed to cause the token to reflect its corresponding PAN in encrypted form. Typically, unless encryption is employed (and except for sharing the BIN), the specific digit values making up a token would not indicate the corresponding digits of the PAN which it replaces. In some embodiments, the nineteenth digit may be generated to serve as a check digit in the same fashion as is conventionally used with the sixteenth digit in a PAN.

In some embodiments, it may be desirable to select the sixteenth digit of the token to have a value such that it would not satisfy the check digit requirements for the sixteenth digit of a PAN. This may be desirable as a precaution against transmission errors or the like that could truncate the token to 16 digits. In such a case, the selection of the sixteenth digit of the token so as not to satisfy the PAN check digit requirement would forestall the potential for mistaking a truncated token for a valid PAN. This same logic could apply for any location of the check digit within the PAN, ensuring that the equivalent location on the token does not satisfy the check digit requirements of a PAN.

In the example embodiment described above, all PANs are constrained to have exactly 16 digits and all tokens are constrained to have exactly 19 digits. However, numerous other sets of prescribed lengths for indicator numbers are possible, provided that the number of digits specified for tokens is different from the number of digits specified for PANs. The number of digits specified for tokens is preferably larger than the number of digits specified for PANs, but this need not necessarily be the case; i.e., the number of digits specified for tokens may be smaller than the number of digits specified for PANs. In embodiments where the PAN length exceeds the token length, a precaution could be taken to ensure that the token does not satisfy a valid PAN check digit if trailing zeros are inadvertently appended to reflect a valid PAN length. In some embodiments, the prescribed length for PANs and the (different) prescribed length for tokens may vary from BIN to BIN.

At 308 in FIG. 3, token service provider computer 104 may store at least some of the PANs generated at 304 and tokens generated at 306 in a manner such as to indicate a mapping of tokens to PANs that they represent. The mapping of tokens to PANS may be stored in a suitable database, such as the above-mentioned token vault 110. FIG. 3A pictorially illustrates a mapping of tokens to PANs that may occur in the token service provider computer 104 in connection with step 308. For example, a number of tokens 352-1 through 352-M are mapped to PAN 354-1, to indicate that those tokens may represent PAN 354-1 in portions of the functioning of the payment system 100. Also, token 356 is mapped to PAN 354-2 to indicate that the latter token may represent PAN 354-2 in portions of the functioning of the payment system 100. Moreover, a number of tokens 358-1 through 358-N are mapped to PAN 354-P to indicate that the latter group of tokens may represent PAN 354-P in portions of the functioning of the payment system 100.

Although only three PANs are explicitly shown in token vault 110 in FIG. 3A, in practice, the number of PANs stored therein, with tokens mapped thereto, may be quite a large number, say in the millions. Similarly, the number of tokens mapped to PANs in the token vault 110 may be in the millions. From previous discussion it will be appreciated that all of the PANs 354-1 through 354-P may be of the same prescribed uniform length, such as 16 digits in some embodiments. Also, all of the tokens mapped to the PANs may be of a prescribed uniform length that is different from the length of the PANs. For example, in embodiments where the uniform length of the PANs is 16 digits, one possibility is that the uniform length of the tokens may be 19 digits.

Referring again to FIG. 3, block 310 may also be included in the process. At block 310, the token service provider computer 104 may take steps necessary to maintain the token vault 110 and the token-to-PAN mapping stored in the token vault 110. This may, for example, include updating the token vault as life cycle events occur relative to tokens and/or PANs.

Continuing to refer to FIG. 3, the token service provider computer 104 may also handle transactions, as represented at block 312. Some details of transaction handling by the token service provider computer 104 will now be described with reference to FIG. 4. In ensuing discussion, it will be assumed that the process steps illustrated in FIG. 4 are performed by the token service provider computer 104. Alternatively, however, the process of FIG. 4 (or portions thereof) may be performed at one or more of the issuer 112, the acquirer 116, or a payment processing service (i.e., by a computer operated by one of those entities). The ensuing discussion also assumes that the standard number of digits specified for PANs is 16 and the standard number of digits specified for tokens is 19; in embodiments with other numbers of digits specified for the indicator numbers, the process of FIG. 4 may be modified accordingly. As noted above, and in any case, the specified standard number of digits for tokens will, according to aspects of this disclosure, differ for tokens vis a vis PANs.

Block 402 in FIG. 4 represents a transaction—most likely an authorization request—being received at the token service provider computer 104. As suggested by block 402, the authorization request may have originated from the merchant 114 (FIG. 1); more specifically the authorization request may have been routed to the token service provider computer 104 via the acquirer 116.

It will be assumed that the authorization request contains an indicator number as the appropriate data element in the authorization request. What is not yet known to the token service provider computer 104 is whether the indicator number is a PAN or a token. To make that determination, decision block 404 follows block 402. At decision block 404, the token service provider computer 104 detects the length of the indicator number. That is, in the example embodiment assumed above, the token service provider computer 104 determines whether the indicator number consists of 16 digits or 19 digits. This may be done, for example, by examining the seventeenth through nineteenth digit locations in the relevant data element to determine whether those digit positions are filled with null/space characters (i.e., nonzero null characters). If so, then the length of the indicator number is sixteen digits, and the indicator number is determined to be a PAN. Otherwise, the indicator number is determined to be a token containing 19 digits.

In some embodiments, the authorization request may contain a length indicator field for the indicator number data element, such that the length indicator field will contain the value “16” if the indicator number is a PAN, or the value “19” if the indicator number is a token. In such embodiments, the token service provider computer 104 may make the determination at block 404 based on the value of the length indicator field, and so would not need to examine the last three digit locations in the indicator number data element.

In the case where the indicator number is determined to be a PAN, the process of FIG. 4 branches from decision block 404 to block 406. At block 406, the token service provider computer 104 may route the authorization request on to the issuer 112, which will then process the authorization request based on the PAN as included in the authorization request as received by the token service provider computer 104.

In the case where the indicator number is determined to be a token, it is necessary for the token service provider computer 104 to translate the token to the PAN which it represents. (That is, de-tokenization must occur.) Accordingly, in this case, the process of FIG. 4 branches from decision block 404 to block 408, at which the token service provider computer 104 accesses the token vault 110 (FIG. 1) to look up the PAN that corresponds to the token contained in the authorization request. The accessing of the token vault 110 is represented by block 410 in FIG. 4.

Following blocks 408 and 410 (if this branch of the process is taken) is block 412. At block 412, the token service provider computer 104 inserts into the authorization request the PAN looked up at block 408 in place of the token that was in the authorization request as received by the token service provider computer 104. With the looked-up PAN inserted into the authorization request, the authorization request may now be routed to the issuer 112. The authorization request can then be processed by the issuer 112 based on the PAN as looked up by the token service provider computer 104 and inserted into the authorization request at 412.

One advantage of the payment system 100, as illustrated in FIGS. 1, 2, 3, 3A and 4 is that the same BINS may be used to generate both PANs and tokens, leading to a more efficient use of the BINs available to a particular issuer, and possibly overcoming what could otherwise be limitations on the size or scope of the payment system 100. Moreover, by using the same BINs for both tokens and PANs, the size of BIN tables may be reduced, thereby possibly leading to efficiencies in data storage and processing. Also, with the above-described arrangement of the payment system 100, at least in some embodiments a very large number of tokens may be available for use within the system.

In one application of the above concepts, with numerous tokens available for a BIN range also shared with PANs, it may be desirable to personalize all the payment cards for a family for different tokens (each unique to a respective physical card) tied to the same PAN, and with the PAN not indicated on or stored in any one of the physical cards. In such an application, if one of the family members loses his/her card, then the card can be reissued with a new token tied to the PAN, which can remain unchanged. This may reduce administrative costs incurred when payment cards are lost.

In the embodiments as described above, the determination of whether an indicator number is a PAN or a token may be made by the token service provider. However, in an alternative embodiment, as illustrated in FIG. 5, and in at least some cases, that determination may be made by the acquirer. It will be assumed that the process illustrated in FIG. 5 is performed by a computer operated by the acquirer 116 shown in FIG. 1. The acquirer computer (which also will now be associated with reference numeral 116) may have the same sort of hardware architecture as was illustrated in FIG. 2. Thus, the acquirer computer 116 may be constituted by the same types of hardware components, interconnected in the same manner, as in the hardware description that accompanied FIG. 2. Moreover, the acquirer computer 116 may be programmed with program steps that are stored therein and that cause the acquirer computer 116 to provide functionality as described now with reference to FIG. 5. It will be understood that FIG. 5 is a flow chart that illustrates a process that may be performed by the acquirer computer 116.

As was the case with the discussion of FIG. 4, it is assumed for the purposes of FIG. 5 that all PANs have a uniform length of 16 digits and that all tokens have a uniform length of 19 digits.

At block 502 in FIG. 5, the acquirer computer 116 receives a transaction (e.g., an authorization request) from a merchant. It will be assumed that the authorization request contains an indicator number as the appropriate element in the authorization request. At this point, the acquirer computer 116 does not yet know whether the indicator number is a PAN or a token. To make that determination, decision block 504 follows block 502. At decision block 504, the acquirer computer 116 detects the length of the indicator number. That is, in the example embodiment assumed for purposes of current discussion, the acquirer computer 116 determines whether the indicator number consists of 16 digits or 19 digits. This may be done, for example, by examining the seventeenth through nineteenth digit locations in the relevant data element to determine whether those digit positions are filled with null/space characters (i.e., nonzero null characters). If so, then the length of the indicator number is sixteen digits, and the indicator number is determined to be a PAN. Otherwise, the indicator number is determined to be a token containing 19 digits.

In some embodiments, the authorization request may contain a length indicator field for the indicator number data element, such that the length indicator field will contain the value “16” if the indicator number is a PAN, or the value “19” if the indicator number is a token. In such embodiments, the acquirer computer 116 may make the determination at block 504 based on the value of the length indicator field, and so would not need to examine the last three digit locations in the indicator number data element.

In the case where the indicator number is determined to be a PAN, the process of FIG. 5 branches from decision block 504 to block 506. At block 506, the acquirer computer 116 may route the authorization request directly on to the issuer 112 or through the payment network 106, and the issuer 112 will then process the authorization request based on the PAN as included in the authorization request as received by the acquirer computer 116.

In the case where the indicator number is determined to be a token, then the process of FIG. 5 may branch from decision block 504 to block 508. At block 508, the acquirer computer 116 may route the authorization request to the token service provider computer 104 so that the token service provider computer 104 may perform de-tokenization. From this point forward, the further processing of the transaction may, for example, resemble the use case illustrated in FIG. 4 of the above-referenced Tokenization Standard.

In some embodiments, during the processing of block 508, the acquirer computer 116 may insert a flag in the authorization request to signal to the token service provider computer 104 that the indicator number in the authorization request has already been determined to be a token rather than a PAN.

With a process as shown in FIG. 5 (i.e., with the acquirer making the PAN vs. token determination) the amount of message traffic sent to the token service provider computer 104 may be reduced and the processing of authorization requests that already contain PANs may be streamlined. Moreover, if the payment system 100 is arranged such that every acquirer performs the process of FIG. 5, then the process of FIG. 4 can be modified and simplified, such that the token service provider computer 104 need not be required and constituted to make the PAN vs. token determination.

As was noted above, the fixed length of the PANs and the (different) fixed length of the tokens may vary from BIN to BIN. Accordingly, the processes described above for determining whether an indicator number is a PAN or token may include accessing a data record corresponding to the BIN of the indicator number, and determining from the data record what the specified lengths are, for that BIN, of the PANs and tokens that share the BIN in question.

As used herein and in the appended claims, the term “BIN” should be understood to include IINs as well as BINs.

As used herein and in the appended claims, the term “computer” should be understood to encompass a single computer or two or more computers in communication with each other.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices.

The flow charts and descriptions thereof herein should not be understood to prescribe a fixed order of performing the method steps described therein. Rather the method steps may be performed in any order that is practicable.

The term “payment card network” or “payment network” is used to refer to a payment network or payment system such as the systems operated by MasterCard International Incorporated (which is the assignee hereof), or other networks that process payment transactions on behalf of a number of merchants, issuers and cardholders.

As used herein and in the appended claims, the term “payment card system account” includes a credit card account, a deposit account that the account holder may access using a debit card, a prepaid card account, or any other type of account from which payment transactions may be consummated. The terms “payment card system account” and “payment card account” are used interchangeably herein. The term “payment card account number” includes a number that identifies a payment card system account or a number carried by a payment card, or a number that is used to route a transaction in a payment system that handles debit card and/or credit card transactions. The term “payment card” includes a credit card, debit card, prepaid card, or other type of payment instrument, whether an actual physical card or virtual.

Although the present disclosure has been described in connection with specific exemplary embodiments, it should be understood that various changes, substitutions, and alterations apparent to those skilled in the art can be made to the disclosed embodiments without departing from the spirit and scope of the disclosure as set forth in the appended claims.

What is claimed is:

1. A method comprising:
receiving a bank identification number (BIN) that defines a range of indicator numbers;
generating a plurality of primary account numbers (PANs) that start with the BIN; and
generating a plurality of tokens that start with the BIN.

2. The method of claim 1, wherein:
all of the PANs have a first uniform length that consists of a first number of digits; and
all of the tokens have a second uniform length that consists of a second number of digits that is different from the first number of digits.

3. The method of claim 2, further comprising:
receiving an authorization request;
detecting a number of digits contained in an indicator number included in the authorization request; and
translating the indicator number into a PAN that is different from the indicator number in response to determining that the detected number of digits equals the second number of digits.

4. The method of claim 3, wherein the first number of digits is 16 and the second number of digits is 19.

5. The method of claim 4, wherein:
the authorization request is in a standard format including an indicator number data element, the indicator number data element consisting of 19 character locations, the 19 character locations including a seventeenth character location, an eighteenth character location and a nineteenth character location; and
the detecting step includes determining whether there are non-zero null characters in each of the seventeenth, eighteenth and nineteenth character locations.

6. The method of claim 3, wherein:
the authorization request includes a field length indicator that indicates a number of digits present in the indicator number included in the authorization request; and
the detecting step includes reading a value of the field length indicator.

7. The method of claim 2, wherein the second number of digits is greater than the first number of digits.

8. The method of claim 2, wherein the second number of digits is smaller than the first number of digits.

9. A method comprising:
receiving an authorization request;
detecting a number of digits contained in an indicator number included in the authorization request; and
translating the indicator number into a primary account number (PAN) that is different from the indicator number.

10. The method of claim 9, wherein the translating step is performed in response to determining that the detected number of digits equals a number of digits that corresponds to a prescribed uniform length for tokens.

11. The method of claim 9, wherein the translating step is performed in response to determining that the detected number of digits equals a number of digits that does not correspond to a prescribed uniform length for PANs.

12. The method of claim 9, wherein:
the authorization request is in a standard format including an indicator number data element, the indicator number data element consisting of 19 character locations, the 19 character locations including a seventeenth character location, an eighteenth character location and a nineteenth character location; and
the detecting step includes determining whether there are non-zero null characters in each of the seventeenth, eighteenth and nineteenth character locations.

13. The method of claim 9, wherein:
the authorization request includes a field length indicator that indicates a number of digits present in the indicator number included in the authorization request; and
the detecting step includes reading a value of the field length indicator.

14. The method of claim 9, wherein:
the indicator number included in the authorization request consists of 19 digits; and
the PAN consists of 16 digits.

15. The method of claim 9, wherein the translating step includes looking up the PAN in a database that maps the indicator number to the PAN.

16. A method comprising:
receiving an authorization request; and
determining that an indicator number contained in the authorization request is a token, said determining based on a length of the indicator number.

17. The method of claim 16, further comprising:
transmitting the indicator number to a token service provider for de-tokenization.

18. The method of claim 16, further comprising:
translating the token into a primary account number (PAN) that is different from the token, in response to determining that the indicator number is a token;
wherein the PAN has a length that is different from the length of the token.

19. The method of claim 18, wherein the length of the PAN is shorter than the length of the token.

20. The method of claim 19, wherein the PAN has a length of 16 digits and the indicator number has a length of 19 digits.
